(19) United States
(12) Patent Application Publication
(10) Pub. No.: US 2016/0306690 A1
(43) Pub. Date: Oct. 20, 2016

(54) INTEGRATED TEST DESIGN, AUTOMATION, AND ANALYSIS

(71) Applicant: S2 TECHNOLOGIES, INC., Encinitas, CA (US)

(72) Inventors: Mark Underseth, Carlsbad, CA (US); Ivailo Petrov, San Diego, CA (US)

(21) Appl. No.: 14/691,393

(22) Filed: Apr. 20, 2015

(51) Int. Cl. G06F 11/07; G06F 11/263

(52) U.S. Cl. CPC G06F 11/079; G06F 11/263; G06F 11/0772; G06F 11/0751

(57) ABSTRACT

Features are disclosed for performing integrated test design, automation, and analysis. Such features could be used to provide efficient test planning, execution, and results analysis for multiple sites. The integrated testing interface may obtain test plan data, provide test configurations to hardware or software test runners, and process results from the testing. The integrated interface provides a full-circle testing platform from requirements collection to design to execution to analysis.

### BACKGROUND

1. Field

This application generally describes systems and methods for integrated test planning/design, automation, and analysis.

2. Background

The testing process can be comprised of disconnected required activities. For example, testing software and/or hardware elements of a system under test (“SUT”) includes test design, test automation, test implementation, and test analysis. A typical example of this process may include a team creating one or more documents (e.g., Microsoft Word documents, Google docs, Microsoft Excel, etc.) to represent the test design/plan for testing the SUT. Based on the test design automation is implemented addressing test fixtures and executional control. A test fixture can be defined as setting up and/or tearing down something used to make a test run consistently (repeatable). Executional control can be defined as how a test or set of tests are executed, and optionally in what order, parameters, and how results are captured. Also based on the test design tests are implemented. A test can be defined as a process of investigation to determine if a certain behavior is working as expected—passed or failed. An “automated” test can be implemented using a script, an application, an operating system command, a test framework, etc. A test framework may include features to declare tests, run associated tests, and provide test results. The test logic, when executed, determines correctness. An example of an automated test can be using the Google test framework to write and execute a test using the C/C++ programing language. The Google test framework may execute the implemented tests and record the results. A “manual” test is executed by a person who is required to determine correctness. An example of a manual test may be to trip a physical switch and confirm a desired response is achieved such as illumination of a light or state change for an electronic device. In this example a person(s) is required to manually execute the test process and record the results. Once tests are implemented executing the tests produce results for analysis. Test results are typically sent to computer console and/or a file.

One non-limiting advantage of the features described is to provide a testing system for creating and/or capturing a test design/plan which, once created, is integrated (e.g., overlaid) with the test results and status corresponding to execution for the tests. Another non-limiting advantage of the features described is to provide a testing system which is configured to use a test design/plan as test execution control. This executional control includes, but not limited to, the running of scripts, applications, operating system commands, test frameworks, etc. Another non-limiting advantage of the features described is to provide a testing system which is configured to collect the output of test execution and automatically present the results and status aggregated and integrated together with the test design/plan. A further non-limiting advantage of the features described is to provide a testing system which presents a standardized interface such as an user interface, which receives messages to define, persist, and provide settings used as variables and commands enhancing executional control defined as part of the test design/plan. In concert, the non-limiting advantages described provide an integrated (centralized) testing system to address the disconnected resource intensive nature of test design, test automation, and test analysis required for testing a SUT.

### SUMMARY

In one innovative aspect, an integrated test planning/design, automation, and analysis system is described. The system includes a test manager used for designing/capturing the tests to run, ordering the execution, how to run each of the tests, how to capture the output of the tests when required, settings/configuration for running tests, and documentation describing the purpose of the tests. The summation of this content shall be called the test design. The test manager includes a storage mechanism enabling persisting the test design. The test manager includes information for executing tests represented by the persisted test design. The system includes a test runner that issues a test schema request to the test manager. A test schema contains execution specific content maintained as part of the test design. The test runner receives the test schema used to control the running of the tests based on the persisted test design. The test runner provides aggregated test results based on the tests executed to the test manager. The test manager persist the test results in storage, including maintaining a history of test results. The test manager provides visual representation of the test design in conjunction with the test results based on the test runner execution. The test manager further includes notifications, quality trends, metrics, and other data minding analysis features related to the historical test results persisted in storage.

In another innovative aspect, a method integrated test planning/design, automation, and analysis is provided. The method includes receiving, at a test management application, a test design. The test design includes tests to run, the order of execution, how to run each of the tests, how to capture the output of the tests when required, settings/configuration used for running tests, and documentation describing the purpose of the tests. The method further includes persisting the test design. The method includes receiving a request of the test design specifically used for executional control of the tests by a test runner. The method includes receiving the test results from the test runner and persisting the content. The method provides visual representation of the test results overlaid with the test design. A summary interface may be provided to present a visual representation of the test hierarchy with a most recent test result received from a test runner. In some implementations, the summary interface may include an aggregation of test results. The method further provides historical representation of the test results related to quality trends, metrics, and other data analysis features.

### BRIEF DESCRIPTION OF THE DRAWINGS

Embodiments of various inventive features will now be described with reference to the following drawings. Throughout the drawings, the examples shown may re-use reference numbers to indicate correspondence between referenced elements. The drawings are provided to illustrate example embodiments described herein and are not intended to limit the scope of the disclosure.

FIG. 1 shows a system diagram for an example system under test (SUT).

FIG. 2 shows a system diagram of a simplified example of an integrated testing system (ITS).

FIG. 3 shows a system diagram of another simplified example of an integrated testing system.

FIG. 4 shows an example of an integrated testing system for testing multiple systems under test.

FIG. 5 shows a functional block diagram of an example integrated testing system.

FIG. 6 shows a simplified example of a Schema.

FIG. 7 is an interface diagram showing an example presentation of a Suite and information the Suite may include.

FIG. 8 is an interface diagram showing an example presentation of a Folder and the information the Folder may include.

FIG. 9 is an interface diagram showing an example presentation of a Folder containing a runnable script.

FIG. 10 shows an interface diagram of an example collaborative content editor allowing content to be created, updated, etc.

FIG. 11 shows an interface diagram of an example a file manager interface.

FIG. 12 shows an interface diagram of an example of a discussion board interface.

FIG. 13 shows an interface diagram of an example of a discussion message creation interface.

FIG. 14 shows an interface diagram of an example test design to-do interface.

FIG. 15 is a document diagram showing an example of a Schema.

FIG. 16 shows a simplified example of a Schema when integrated with test results.

FIG. 17 is an interface diagram showing an example of an individual test report.

FIG. 18 is an interface diagram showing an example of an integrated interface presenting the test design along with at least a portion of the results status.

FIG. 19 is an example of a report interface displaying growth of passing tests over time.

FIG. 20 is an interface diagram showing an example of a custom metric interface.

FIG. 21 is an interface diagram showing an example of a report including a captured custom metric over a period of time.

FIG. 22 is a process flow diagram illustrating a method of integrated test planning/design, automation, and analysis.

### DETAILED DESCRIPTION

In a test design and/or test plan (hereinafter “test design”), used for both manual and automated tests, the capturing of the requirements, textural and or visual description of the tests, repeatable test procedures for manual tests, run commands, settings, execution order, fixture setup and teardown, etc., would not be connected in a centralized and integrated fashion with the results and status based on the running of the tests. Furthermore, changes in test implementation, information collected (e.g. logs) during the running of tests, and the assessment of the behavior of the tests, would not be reflected in the test design in which they are included. Conversely, updates to the test design would not be automatically included in the execution and the implementation of the tests.

In one implementation, the integrated testing system (ITS) includes a test manager and a test runner. The test runner may be implemented in software as a standalone application or embedded within the test manager. The test runner may execute on a server, desktop, tablet, cell phone, or any other type of electronic device. The test runner may communicates with the test manager through standard channels such as internal messaging, function calls, TCP, web-services, etc. (hereinafter “communication channel”).

The test runner may include features to initialize a test, run a test, collect and aggregate results from a test, collect and annotate logs from a test, pass parameters to a test, time the duration of test, and terminate a running test. Additionally, the test runner may display test instructions for a manual test. The test runner may include the above features on a collection of tests. Furthermore, the test runner may be controllable via a normal user interface (e.g., console) or through a communication channel.

The test manager may be implemented as a standalone application or a distributed application. The test manager may be hosted on a remote (e.g., cloud based) server, local server, desktop, tablet, cell phone, or any other type of electronic device. The test manager may be in communication with a database or other file systems for persisting information. The test manager may provide a user interface for receiving and displaying a test design alone or in conjunction with test status. Furthermore, the test manager may be controllable through a communication channel.

The test manager may represent the test design by creating a tree structure diagram (hierarchy) reflecting how tests are functionally grouped together with similar test coverage objectives, along with executional control requirements of the tests. The tree structure (hereinafter “test schema”) may be created using Suite and Folder items. A Suite represents an executable unit, with optional settings, containing one or more Test Cases. Suite settings can be defined as executional control details (e.g., how to run the Suite) or input parameters to the Suite. A Suite can also contain procedural instructions for user consumption regarding a manual test. A Test Case can be defined as steps required to determine a status of expected behavior (e.g., correctness) and optional Annotations. An Annotation represents supplemental information obtained during test execution (e.g., logs). A Folder can be defined as a container of other Folders and or Suites used for reflecting the organizational aspect of the test design. A Folder also contains settings used to define/reference “schema variables” or define executable commands (such as via a script of executable instructions). Schema variables are name-value pairs used within the test design to provide access to internal attributes of the Schema (e.g., names, paths, etc. of Folders and Suites), or uniquely create user-defined attributes. Schema variables defined in a Folder can be references by any of its children items (e.g., Folders and Suites). Suites and Folders also may contain textual descriptions reflecting their purpose.

The test manager may include a module for creating Folder and Suite items. The test manager application may receive textual descriptions which are associated with the Folder and Suite items. Textual descriptions may include hyper-links to associated wiki articles, attached documents/images, discussions, to-do lists, or external content.

The test manager may be configured to receive one or more messages to order, re-order, move, disable, enable, etc., of Folders and Suites. The messages may indicate the execution control requirements for items in the test schema. For example, if a Suite is under construction, it may be desirable to include the Suite for display via the test manager, but disable the execution of the Suite. This provides a system which maintains a consistent view of the test design, even when not all tests are implemented or active.

The test manager may be configured to receive messages for editing, deleting, renaming, etc., of Folders and Suites included in the test schema. Editing may include updating, removing, etc., of textual descriptions and or settings associated with Folders and Suites. These features also help maintain a consistent view of the test status associated with updates to the test design.

The test manager may further reflect the test design by associating Wiki documentation, file attachments, Discussion board messages, and planning actions (e.g., to-do list) with the test schema. The test manager may receive test results configured to integrate/overlay with the test schema, centralizing the test design with the test status. The test manager may receive discussion comments, links, images, etc., used to analyze the test status associated with the test design. The test manager may receive requests for test reports displaying historical metrics, trends, etc. associated the test design.

The test manager may include a module for creating and maintaining wiki documentation to be associated with the test schema. A wiki article may include an identifier for a Folder or Suite included in the test schema. The wiki document is thus integrated with the identified test schema element such that activation of a control may initiate display of the associated Folder or Suite item. Conversely, the Suite or Folder may be associated with a wiki article. As the Suite or Folder is presented, a control element may be presented which, when activated, causes display of the corresponding wiki document.

The test manager may maintain documentation attachments (Word, Excel, PDF, images, etc.). Documents may be uploaded to the test manager and associated with the test schema. The test manager may associate a Folder or Suite with an attached file. As the Suite or Folder is presented, a control element may be presented which, when activated, causes display of the corresponding document.

The test manager may include a discussion board module. The discussion module may be configured for real time or offline communication between users about a Folder, Suite, latest results, overall test design, etc. The communication may be voice, text, video, or a combination thereof (hereinafter a “message”). In some implementations, the message may include file attachments. Messages are captured by the test manager and associated with the test design. A message is thus integrated with the identified test schema element such that activation of a control may initiate display of the associated Folder or Suite item. Conversely, the Suite or Folder may be associated with a message. As the Suite or Folder is presented, a control element may be presented which, when activated, causes the presentation of the corresponding message.

The test manager may include a to-do module. The to-do module may be configured for defining follow-up actions for users about a Folder, Suite, latest results, overall test design, etc. The follow-up action may be a list, text, voice, video, or a combination thereof used for tracking activity. In some implementations, the follow-up action may include (or be a part of) a discussion message. Follow-up actions are captured by the test manager and associated with the test design. A follow-up action is thus integrated with the identified test schema element such that activation of a control may initiate display of the associated Folder or Suite item. Conversely, the Suite or Folder may be associated with a follow-up action. As the Suite or Folder is presented, a control element may be presented which, when activated, causes the presentation of the corresponding follow-up action.

The test manager may include a reports module. The reports module may be configured for maintaining historical test results associate with the test design. Test results may be uploaded to the test manager and maintained indefinitely. The module may provide data minding features for test analysis based on the historic data presenting quality trends, metrics, SUT health indicators, etc. The test manager may include a user interface for the definition of custom metrics to be calculated and maintained with the test results collected.

The test manager may be further configured to provide access (e.g., visual display or machine interface to a computer readable representation) to the test schema. The access may be provided through a communication channel. The test manager may enable the test runner, via a communication channel, to access a test schema. The representation of the test schema provided includes information reflecting the execution order, commands required to run a test or set of tests, schema variables, input parameters, status of Folders or Suites (e.g., enabled, disabled), indications of implemented Suites or Suites planned but not yet implemented, etc., for testing the SUT.

A test runner may be provided in another innovative aspect. The test runner is configured to automatically access the test manager to obtain at least a portion of the defined test schema. The obtained portion may serve as an input for test execution control. The test runner interprets the content of the test schema, executing commands, resolving schema variables, providing input to Suites, running scripts, etc. The test results generated by the execution of tests are collected, aggregated, and published via a communication channel to the test manager to be overlaid with the test design and persisted.

The test manager may aggregate the output to determine a status for the Suites included within a test schema. In some implementations, the status may be reported as “all working” if each Suite reports that the Suite passes the test criteria. In some implementations, the status may be reported as a quantity of tests working (e.g., percent, ratio, absolute number). Aggregated total output of Suite status, Test Cases, timing, etc., may be generated and provided by the test manager. In some instances, the status and/or output may be referenced within the test schema in association with an execution instance. An execution instance generally refers to a specific running of the tests. The test manager may provide, in conjunction with or in alternative to the aggregate status, status of individual Test Cases corresponding to Suites.

The features described may be included in systems or methods for test design which includes automation and test analysis. One non-limiting advantage of the features described is the integrated collection, storage, and presentation of testing results and status with the test design. Centralization presents a combined view of the test design automatically connected/overlaid with the current testing status. Such a unified representation facilitates communication of team members with a holistic view of both the test design and current test implementation status. This representation optimizes addressing issues (e.g. resolving problems) by centralizing interdependent critical content and integrating previously disconnected activities. A further non-limiting advantage of the described features is providing a test runner fully automated to leverage the test design as input for executional control of running tests. Using test design for test execution automatically synchronizes the two separate activities. Test design is fully synchronized with test execution, thus integrating the design and execution activities.

Although the examples and implementations described herein focus, for the purpose of illustration, on test design, automation, and analysis, one skilled in the art will appreciate that the techniques described herein may be applied to other processes, methods, or systems. For example, the techniques may be used with other types of systems which coordinate activities for purposes other than testing such as training, task management, or workflow management. Various aspects of the disclosure will now be described with regard to certain examples and embodiments, which are intended to illustrate but not limit the disclosure.

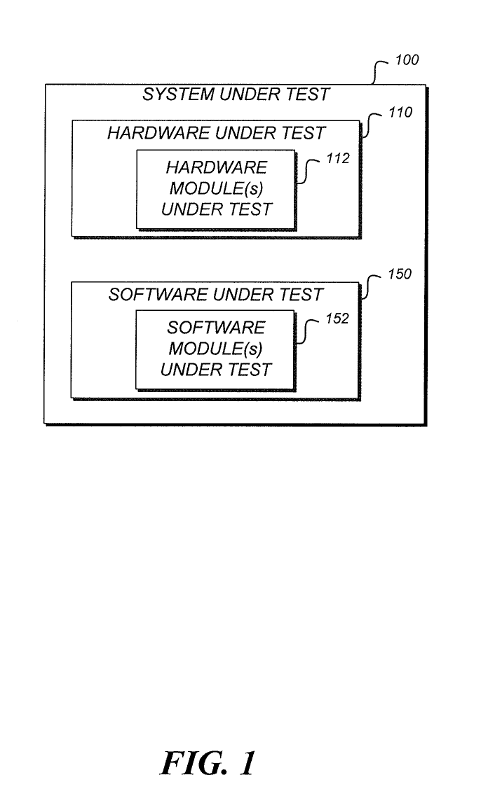

FIG. 1 shows a system diagram for an example system under test (SUT). The system under test 100 may include hardware under test 110. The hardware under test 110 may include a hardware module under test 112. For example, a display monitor may be the hardware under test 110 and the brightness control may be the hardware module under test 112. The system under test 100 may include software under test 150. The software under test 150 may include a software module under test 152. For example, an embedded application may be the software under test 150 and the network communication module may be the software module under test 152. Although not shown in FIG. 1, the system under test 100 may include multiple hardware under test and/or multiple software under test. Furthermore, the hardware under test 110 may include several hardware modules under test and the software under test 150 may include several software modules under test. The system under test may execute on a server, desktop, tablet, cell phone, or any other type of electronic device (hereinafter “platform”).

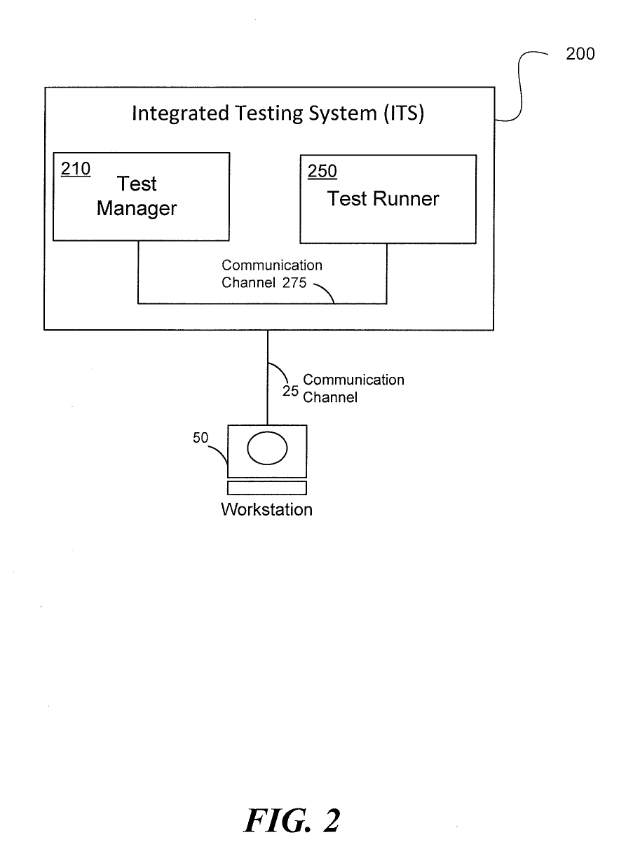

FIG. 2 shows a system diagram of a simplified example of an integrated testing system (ITS). The integrated testing system 200 may be implemented as a test manager 210, and a test runner 250. The test manager 210 may be hosted on a platform. The test runner 250 may be hosted on a platform. In some implementations, the test manager 210 may be co-located with the system under test 100 and or co-located with a test runner 250. The test manage 210 may be disparately located. In some implementations, the test runner 250 may be co-located with the system under test 100 and or co-located with a test manager 210. The test runner 250 may be disparately located.

As shown in FIG. 2, the test manager 210 and the test runner 250 may communicate messages via interfaces such as operating system shell commands, function calls, internal messaging, TCP, web-services, etc. Interfaces may be configured to use wired (e.g., Universal Serial Bus (USB), cross-over Ethernet, IEEE 1394 Firewire™, etc.) or wireless (e.g., IEEE 802.15, IEEE 802.11, near field communication, infrared, etc.) connection types. Communication using an interface type hosted on a connection type is referred to herein as a communication channel 275.

The integrated testing system 200 may communicate with a workstation 50. The workstation may be configured to transmit messages to define and/or alter a test design. The messages may be transmitted using a communication channel 25. The workstation 50 may be hosted on a platform. In some implementations, the workstation 50 may be co-located or disparately located. In some implementations a workstation 50 may be hosted on the same device as the system under test 100 or on the integrated testing system 200.

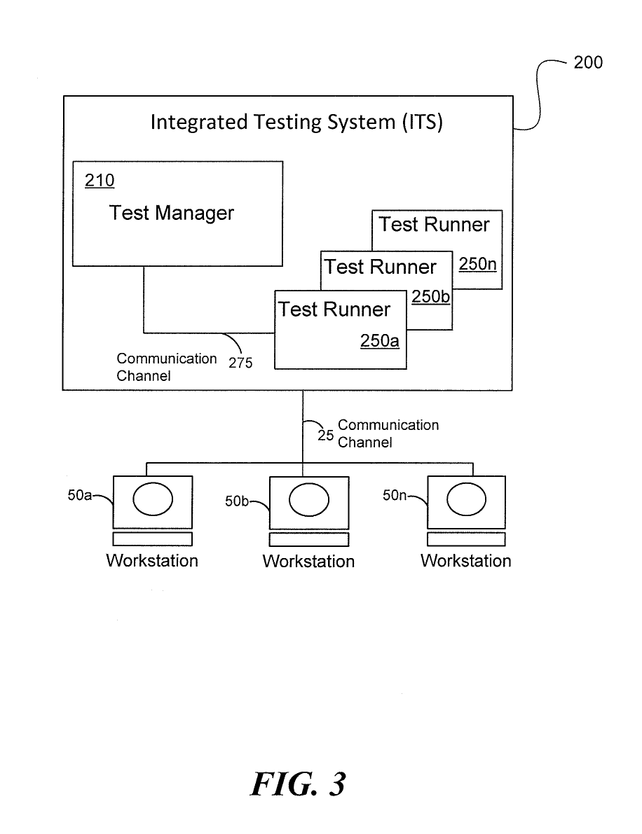

FIG. 3 shows a system diagram of another simplified example of an integrated testing system. As shown in FIG. 3, the integrated testing system 200 may be implemented using a test manager 210 and multiple test runners 250a-250n, where “n” represents any number of entities. Also multiple workstations 50a-50n may be configured.

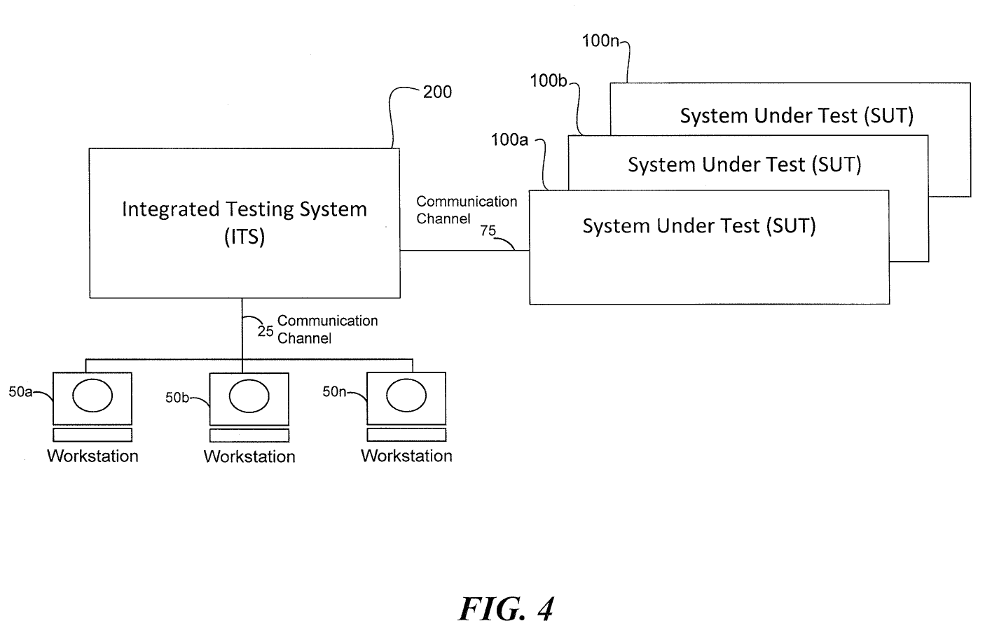

FIG. 4 shows an example of an integrated testing system for testing multiple systems under test. The integrated testing system 200 shown in FIG. 4 includes a communication channel 75 with multiple systems under test 100a-100n. Although not shown in FIG. 4, the integrated testing system 200 may include multiple test runners 250a-250n.

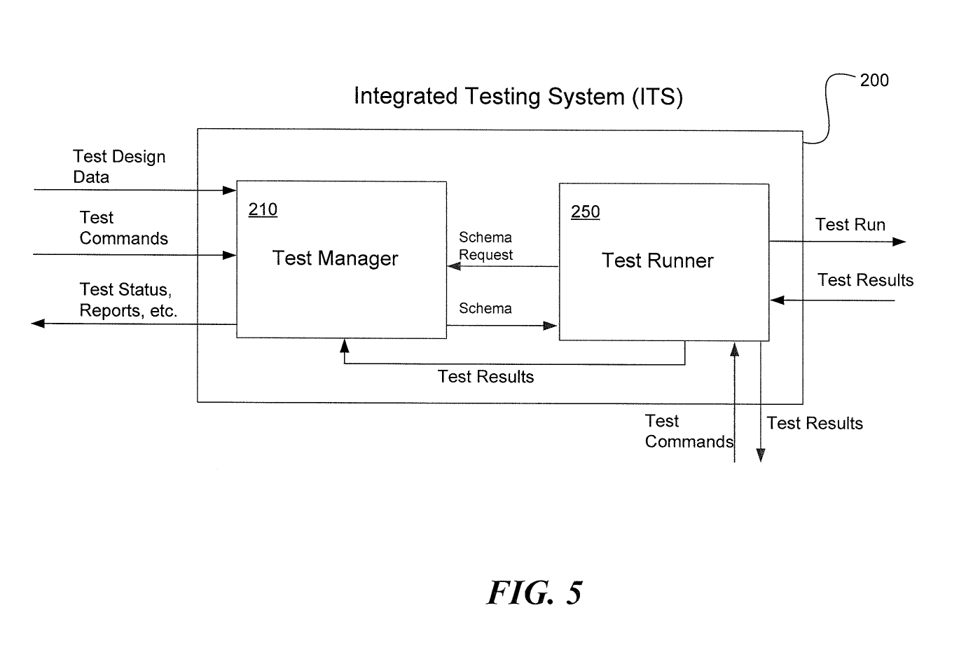

FIG. 5 shows a functional block diagram of an example integrated testing system 200. Note that certain extraneous elements have been omitted to focus the reader on features to be discussed. For example, although not shown in FIG. 5, the integrated testing system 200 may include multiple test runners 250. Additional elements may be added without departing from the intended scope of what constitutes an integrated testing system.

The integrated testing system 200 may include a test manager 210. The test manager receives test design data via a workstation 50a-50n. The test manager may present a test schema (hereinafter “Schema”) to represent the test design data. The Schema is used to capture aspects of the test design, define executional control specifics, and provide relevant test status.

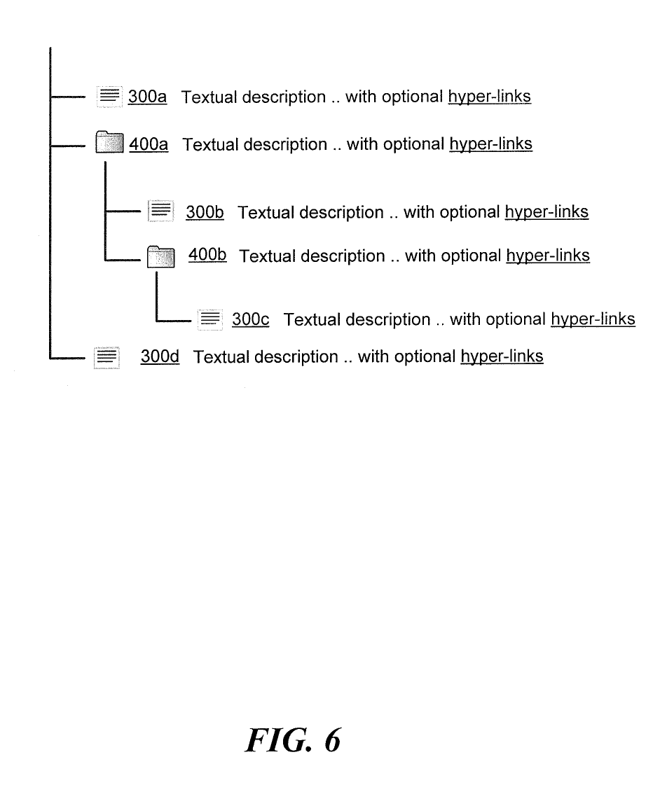

FIG. 6 shows a simplified example of a Schema. The Schema shown in FIG. 6 includes information which is part of the test design. The Schema may be defined as a hierarchy (tree structure) containing Suites 300a through 300d and Folders 400a through 400b. There are no logical limits on the number of Suites or Folders which may be included in the Schema provided the hardware hosting the Schema is appropriately sized (e.g., ample memory). The Schema may be visually displayed in the cascading hierarchical manner shown in FIG. 6. A visual display of the Schema may include interactive elements such as hyper-links configured to access a Folder or Suite associated therewith. Icons may be used to distinguish Folders from Suites. In some implementations, the icons may also be interactive such that when activated cause the system to access the Folder or Suite associated therewith.

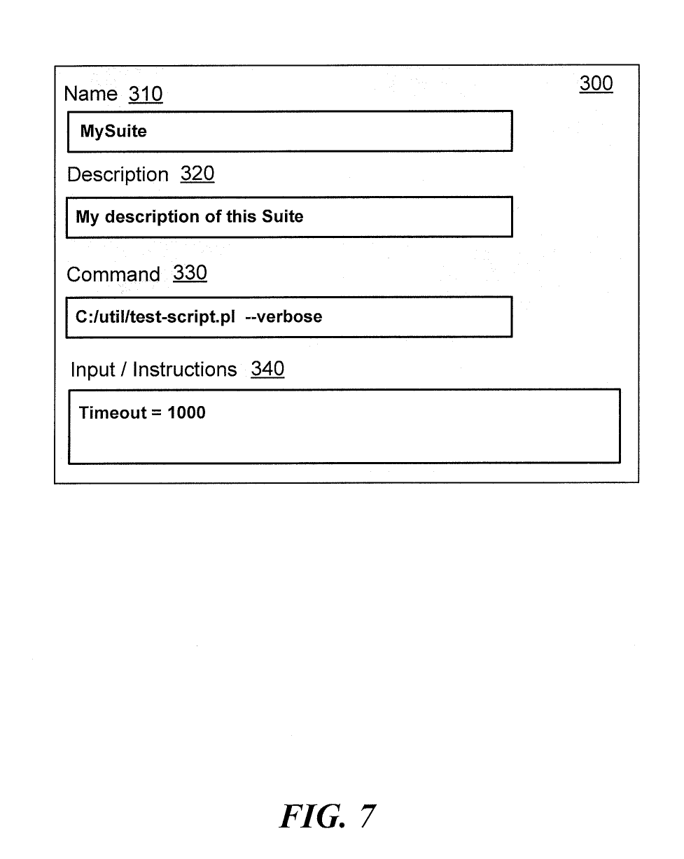

A Suite represents an executable “test” containing one or more test cases. FIG. 7 is an interface diagram showing an example presentation of a Suite and information the Suite may include. A Suite name 310 reflects the name of the test. The Suite description 320 reflects the purpose of the test along with optional hyper-links for more context. The Suite command 330 provides instructions on how to execute an automated test (e.g., a UNIX shell command, execute a Perl script, etc.). The Suite input 340 contains input data or manual test instructions. The name, description, command, or input/instruction information may be provided using input control elements. The input control elements may receive updates to one or more of the values. For example, the Suite name 310 may be displayed in a text field which can be used by a client device (for example a laptop computer, tablet, or other platform) to update the name of the Suite when submitted (e.g., via HTTP POST or GET of the text field form data) to the system.

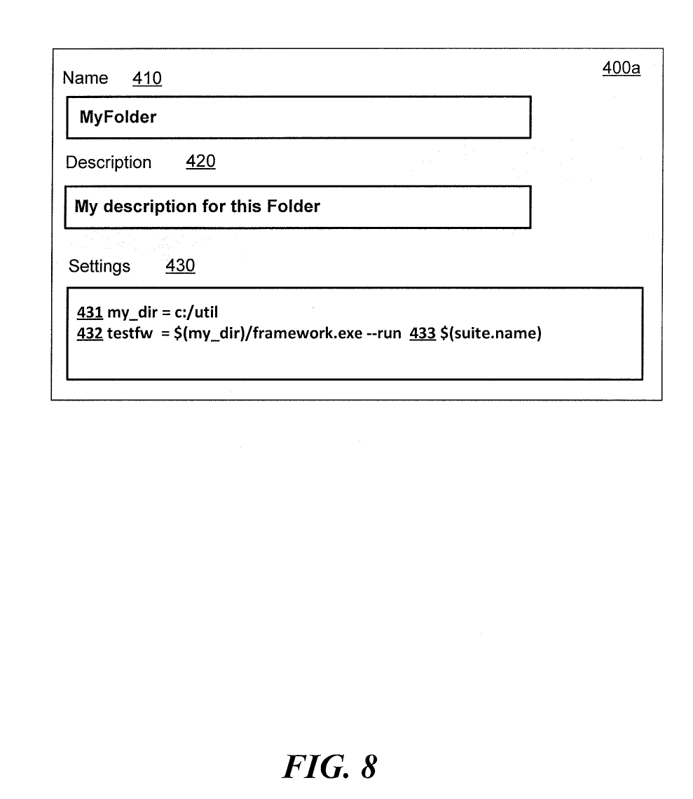

A Folder represents a container of other Suites and or Folders. Folders may be used to reflect organizational aspects of the test design. FIG. 8 is an interface diagram showing an example presentation of a Folder and the information the Folder may include. A Folder name 410 reflects the name of the container. The Folder description 420 reflects the purpose of the Folder 400a and its children along with hyper-links for more context. The Folder settings 430 may represent Schema variables (hereinafter “variables”) and or executable commands (hereinafter “script”).

A Folder's variables may be defined as name-value pairs. User-defined variables may be defined such that they are available to any of the Folder's children (Folders and Suites). Special built-in variables may be provided providing access to field names, path, input, etc. for Suites and Folders. The built-in variables may be resolved at the point of reference or within an executional command. Variables also can be defined using existing variables. In the example shown in FIG. 8, any child Suite of Folder 400a can reference the testfw 432 user-defined variable within its command field. Also, the built-in variable suite.name 433 will be resolved and available for command usage.

The information may be provided using input control elements which receive updates to one or more of the values. For example, the Folder name 410 may be displayed in a text field which can be used by a client device to update the name of the Folder 400a.

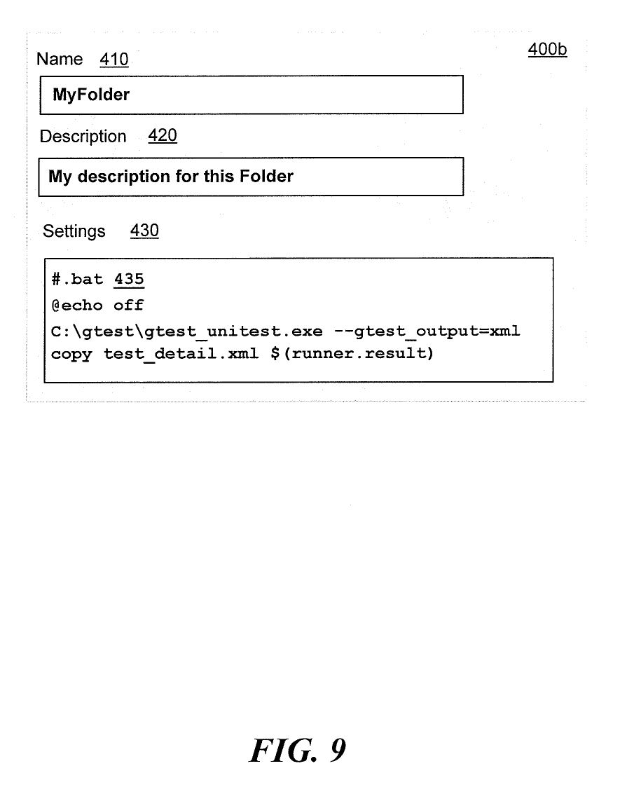

A Folder's settings may also consist of a runnable Script. FIG. 9 is an interface diagram showing an example presentation of a Folder containing a runnable script. The settings may reflect a snippet of code in a scripting language (e.g., Perl, Ruby, Python, Windows batch, shell, etc.). The primary purpose is to execute a set of tests to be presented by a collection of children Suites. As shown in FIG. 8, the Folder 400b includes a Windows batch script 435. The script 435 uses Windows commands to execute a test framework (as shown, the Google™ test framework).

The test manager 210 may receive one or more test data input messages to order, move, copy, disable, enable, etc., of Folders and Suites defined in the Schema from a workstation 50n. Updates may affect the order of execution, set of tests to run, etc. The test manager 210 may receive test design input messages for editing, deleting, renaming, etc., of Folders and Suites included in the test schema from a workstation 50n. Editing may include updating, removing, etc., of textual descriptions, names, scripts, and or settings/input associated with Folders and Suites.

The test manager 210 may receive one or more test data input messages to add additional written content associated with the Schema. The messages may be received from the workstation 100n. The test manager 210 may present a collaborative content editor (e.g., wiki article editor, blog publisher, or other vehicles used for documentation) to capture and or update specific information (one or more articles) related to the Schema.

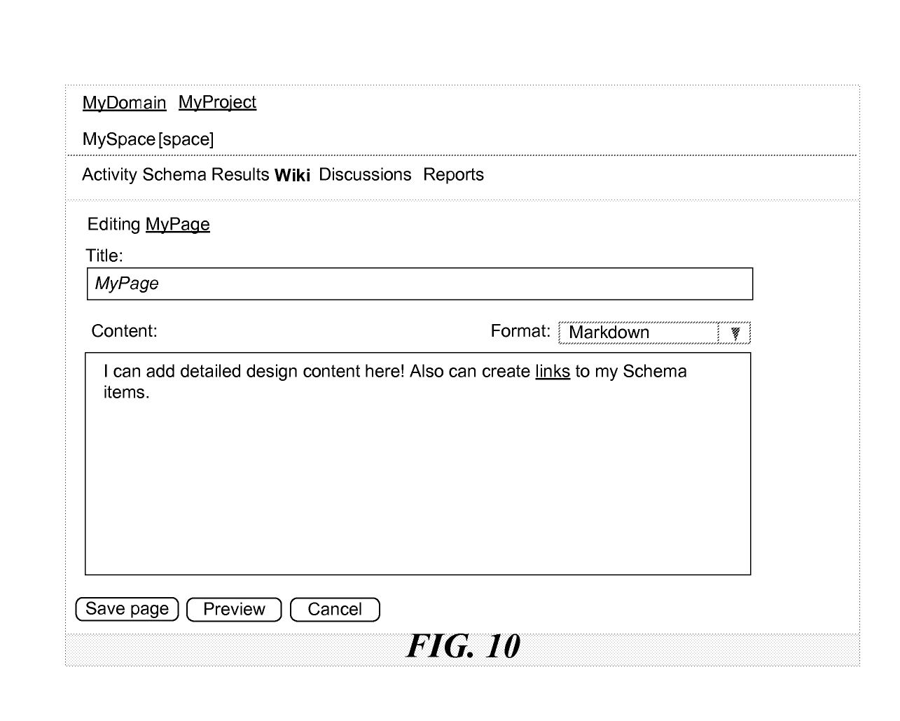

FIG. 10 shows an interface diagram of an example collaborative content editor allowing content to be created, updated, etc. The test manager 210 associates (centralizes) the collaborative content system (e.g., wiki) and content entries contained therein with the Schema. For example, as content is added to the collaborative content system, the content or an identifier therefor (e.g., URL, URI, identifier) may be stored in the Schema. The test manager 210 may thus enable relative hyper-linking of articles and Schema items (such as Folders or Suites). Associating additional written content with the Schema centralizes the test design and generated content related to the test within the integrated system.

The test manager 210 may receive one or more test data input messages to attach (upload) additional documents (e.g., Microsoft™ Word, Microsoft™ Excel, PDF, PNG, MP3, MP4, etc.) to be associated with the Schema from the workstation 100n. The test manager 210 may provide an interactive interface element to add, delete, update, etc., for managing files.

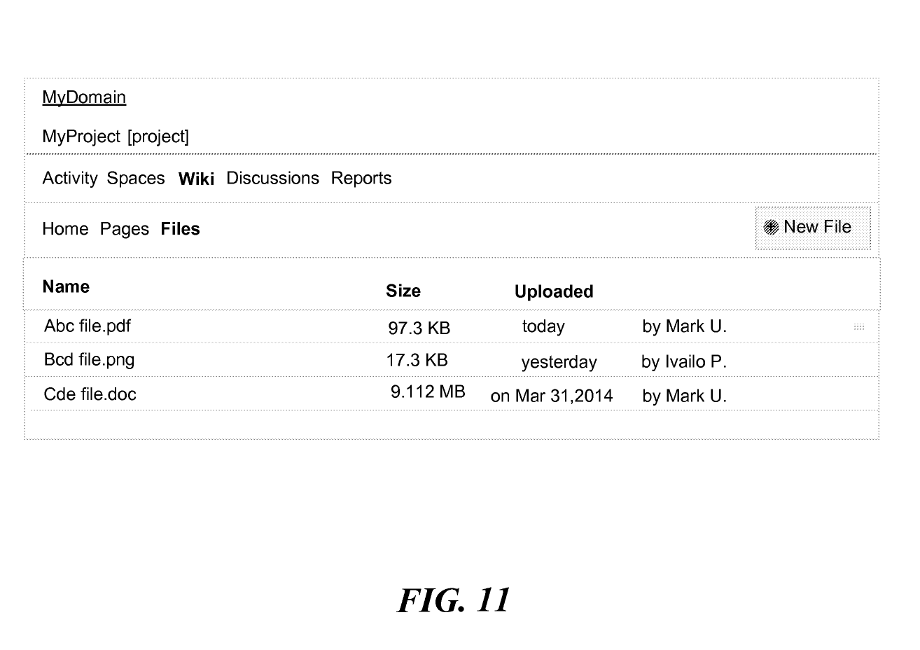

FIG. 11 shows an interface diagram of an example a file manager interface. The file manager interface includes elements allowing documents to be uploaded and centralized as part of the test design. The test manager 210 may enable relative hyper-linking of articles between Schema items (such as Folders or Suites) and the attached documents. Associating additional documents with the Schema facilitates a centralized test design.

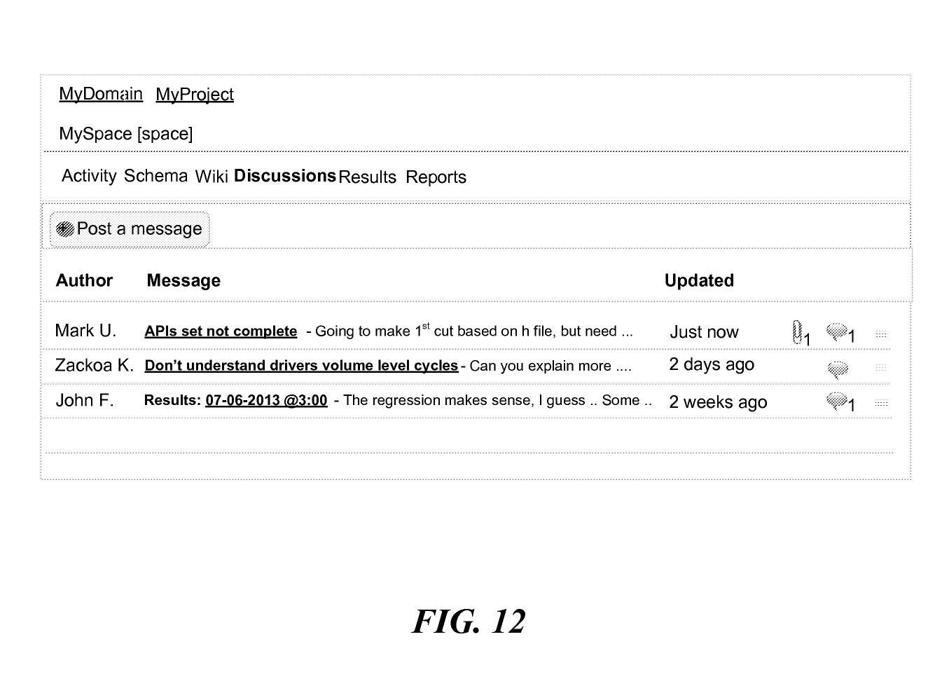

FIG. 12 shows an interface diagram of an example of a discussion board interface. The test manager 210 may receive one or more test data input messages including content discussing the test design associated with the Schema from the workstation 100n. The test manager 210 may provide a form to add, delete, update, etc., for discussion messages.

The discussion board interface shown in FIG. 12 includes interface elements allowing discussion messages to be added, edited, deleted, and commented on, etc., as part of the test design.

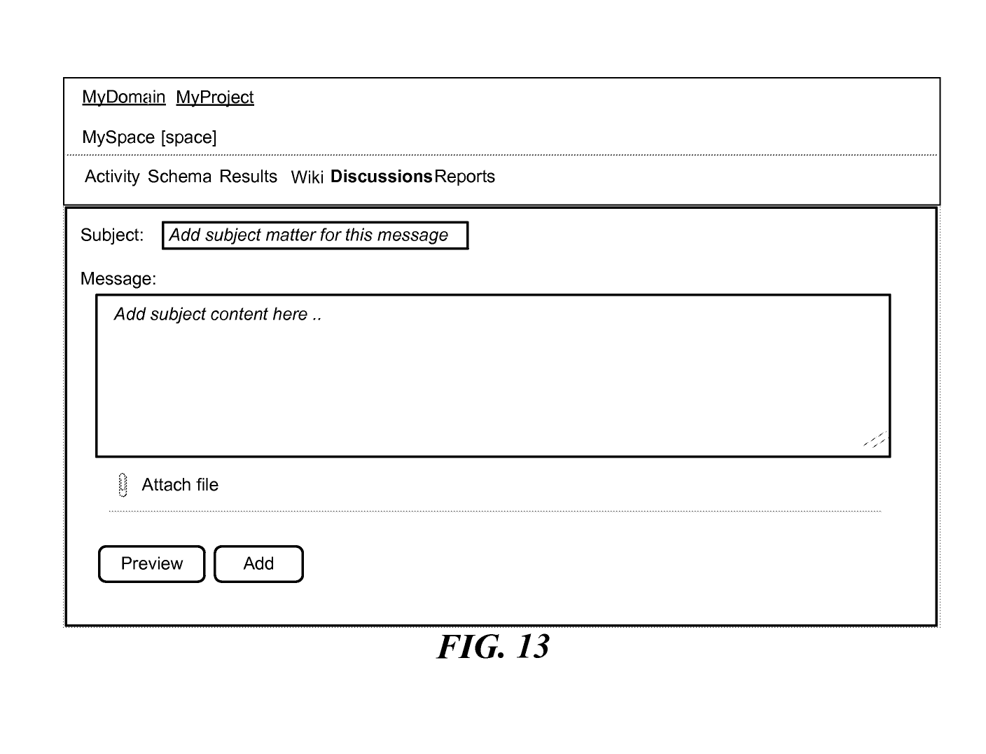

FIG. 13 shows an interface diagram of an example of a discussion message creation interface. The discussion message creation interface may be used to create a discussion message. The test manager may enable relative hyper-linking of articles between Schema items (such as Folders and/or Suites) and the discussion messages. Associating discussion messages with the Schema facilitates a centralized test design.

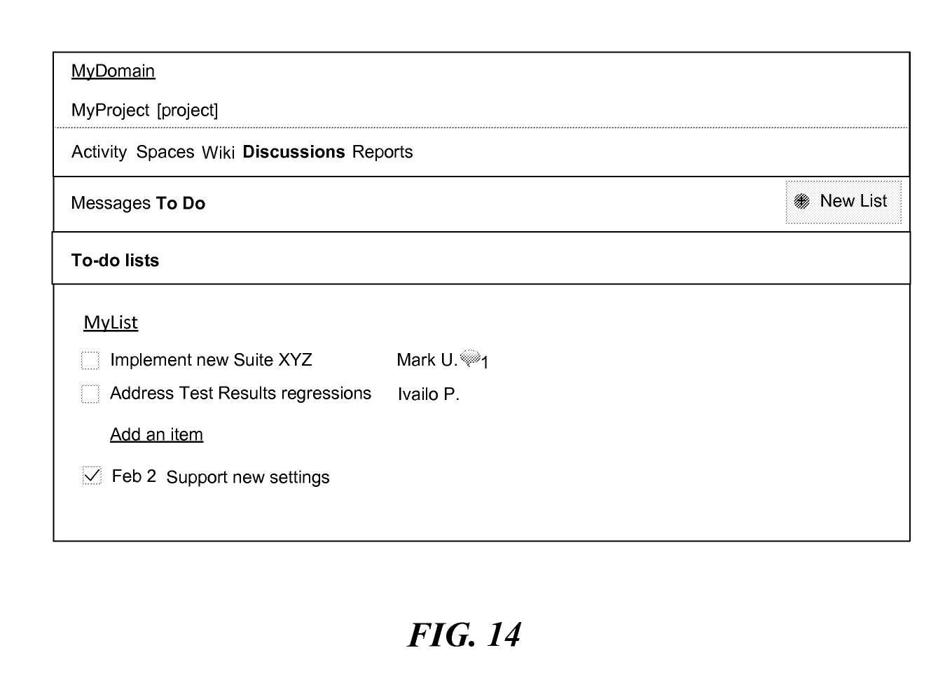

The test manager may receive one or more test data input messages to track actions associated with the test design from a workstation 50n. FIG. 14 shows an interface diagram of an example test design to-do interface. The interface shown in FIG. 14 includes a form to create actionable to-do list and items to be included in the list. The test manager 210 may enable relative hyper-linking of list items between Schema items (such as Folders and/or Suites) and the to-do items. Associating follow-up actions with the Schema facilitates a centralized test design.

As shown in FIGS. 3 and 4, the integrated testing system 200 may include a test runner 250. Based on the system 200 configuration there may be multiple test runners 250a through 250n. The integrated testing system 200 may allocate a single test runner to the system under test 100a, or assign the same test runner to multiple systems under test 100a through 100n. Different test runners 250a through 250n may be assigned to different systems under test 100a-100n. The integrated testing system's test manager 210 may include multiple test designs, multiple unique Schemas, multiple collaborative content systems, etc. The integrated testing system 200 may assign the same test runner 250a, or a different test runner 250b, to the same or different test designs. The integrated testing system 200 may support any combination of test runners 250a through 250n, any combination of system under test 100a through 100n, and any combination of unique test designs.

The test runner 250 may support Test Commands from a console, application, script, etc. The Test Commands may contain the specific test design to use, the system under test 300 to run against, credential information (such as username, password, encryption keys, authorization tokens, etc.), and other configuration content. The test runner 250 may issue a Schema Request to the test manager 210 based on the Test Commands. The test manager may provide the Schema to be used for executional control by the test runner 250. The test manager 210 may instantiate the test runner 250 as a result of receiving a Test Command to run tests via a workstation 50.

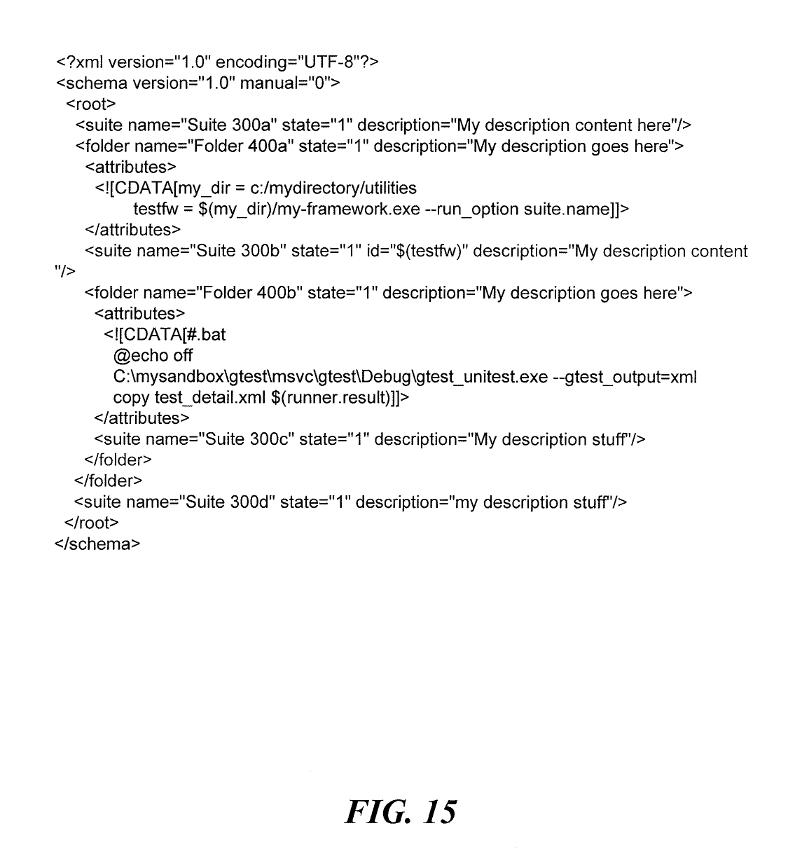

FIG. 15 is a document diagram showing an example of a Schema. The Schema shown in FIG. 15 is represented in extensible markup language (XML). It will be appreciated that the Schema may be represented using alternate or additional machine readable formats. The attribute “name” for elements included in the schema aligns with the schema shown in FIG. 6. For example, Suite 300a is shown as the first element below the root element in FIG. 15. Elements included in the Schema shown in FIG. 15 include an attribute “state” which indicates whether the associated test(s) are enabled. This allows test designers to develop one portion of the test plan within and among other active portions of the test plan. By indicating a test is enabled, when a test runner requests execution information, the enabled test information will be provided while the system may not provide disabled tests. In some implementations, the system may provide all test information and the test runner may be configured to skip tests which are flagged as disabled.

The test runner 250 in some implementations may parse the Schema and execute each of the Suites and or Folders based on the content and ordering. The Suite Command 330 may be executed based on the instructions. A Suite Command 330 may reference a Schema variable that will be resolved and used within the command. A Suite Input 340 may be provided with the test being executed represented by the Suite Command 330. A Suite may be a manual test such that the Suite Input 340 will be presented via a display to be confirmed by a user. A Folder 400a may have variables contained in its Settings 430. Variables may be processed such that they are available to any children of the Folder. A Folder 400b may have a Script contained in its Settings 430. The test runner may invoke the script.

The test runner 250 collects the results generated by the Schema execution and aggregates the content. In some implementations addition information can be added to the test results such as timing, logs, console output, etc. The test result may include additional contextual information about the test execution such as the date of the test, identifier for modules tested, identifier for the test runner, identifier for the system under test, temperature, operational characteristic (e.g., power, load, memory used, memory available, processor type, operating system, etc.) of the system under test or the device executing the test runner, or other information indicative of the test execution or conditions under which the test execution was performed. The test results are provided by to the test manager 210 via a communication channel.

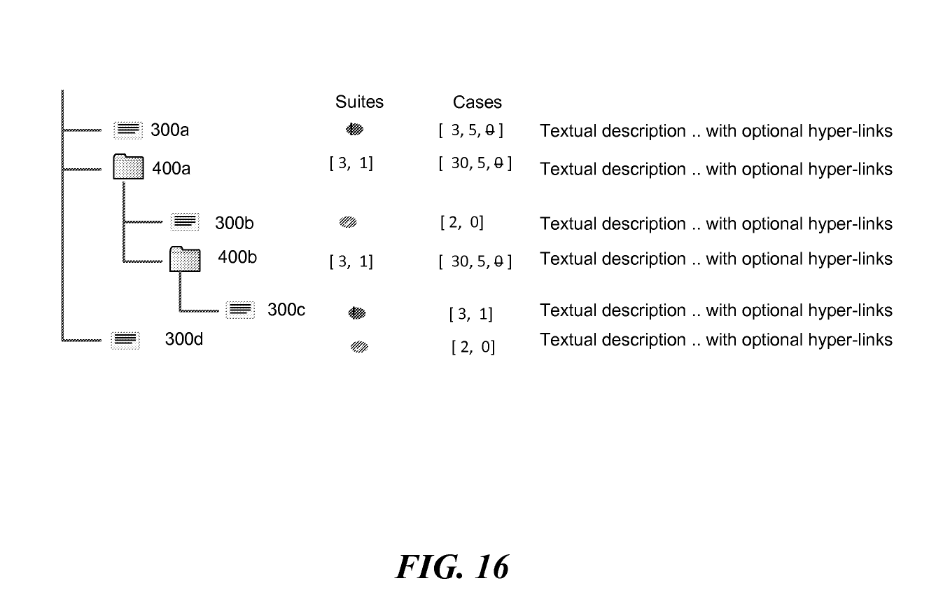

The test manager 210 may aggregate the results to determine a status for the Suites included within a test schema. FIG. 16 shows a simplified example of a Schema when integrated with test results. In some implementations, the status may be reported as “all working” if each Suite reports that the Suite passes the test criteria. In some implementations, the status may be reported as a quantity of tests working (e.g., percent, ratio, absolute number). Aggregated total output of Suite status, Test Cases, timing, etc., may be generated and provided by the test manager. In some instances, the status and/or results may be referenced within the schema in association with an execution instance. An execution instance generally refers to a specific running of the tests.

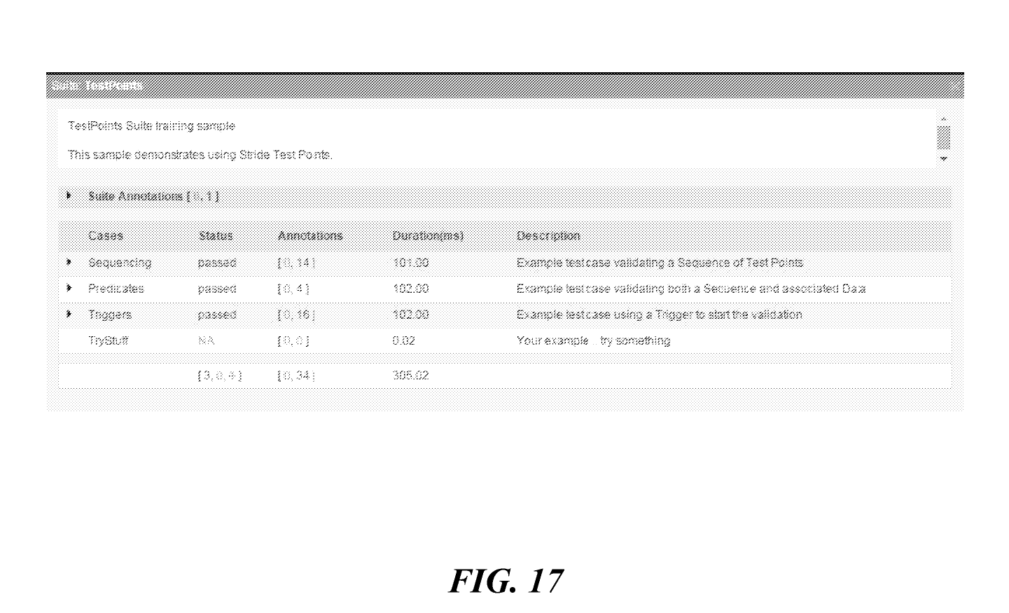

The test manager 210 may provide, in conjunction with or in alternative to the aggregate status, status of individual Test Cases corresponding to Suites. FIG. 17 Error! Reference source not found. is an interface diagram showing an example of an individual test report.

The test manager 210 may provide an integrated view of the test results status, along with the Schema, centralized access to the collaborative content and/or documentation, file attachments, messages, and actionable to-do items.

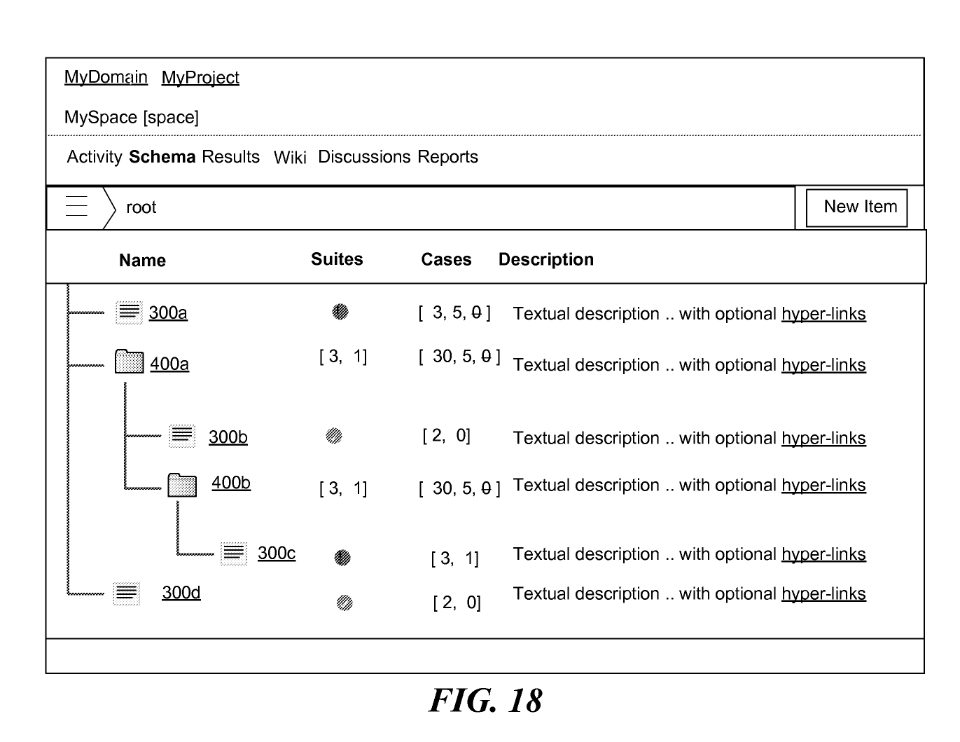

FIG. 18 is an interface diagram showing an example of an integrated interface presenting the test design along with at least a portion of the results status. For example, the Folder 400a includes a summary of the number of suites included in the folder. The summary is shown as “[3, 1]” which indicates three suites passed and one suite did not pass. The Folder 400a also includes a summary of the results from the test cases included in the Folder 400a. As shown, the Folder 400a reports 30 cases passed, 5 failed, and 0 skipped. This result is reported as “[30, 5, 0].”

Within Folder 400a, Suite 300b has passed all tests included in the Suite 300b. A colored icon may be used to summary the pass/fail status of a suite. In addition to summarizing the result for the Suite 300b, the interface includes a column summarizing the cases. For the Suite 300b, 2 passed and 0 failed. This result is reported as “[2, 0].” As shown, the interface may be expanded or collapse to show or hide children elements for a node of the hierarchy. Accordingly, the test design and the test results can be analyzed in an integrated interface.

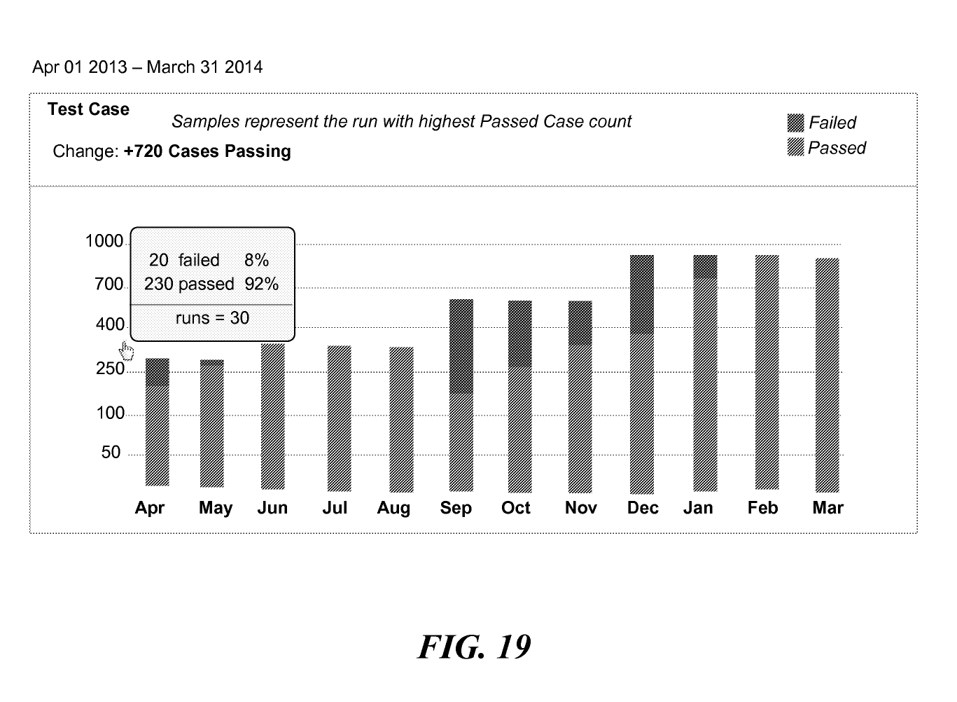

The test manager 210 may receive Test Commands requesting historical reports. FIG. 19 is an example of a report interface displaying growth of passing tests over time. The test manager 210 may provide an integrated view of the test reports, along with the Schema, current status, collaborative content and/or documentation, file attachments, messages, and actionable to-do items.

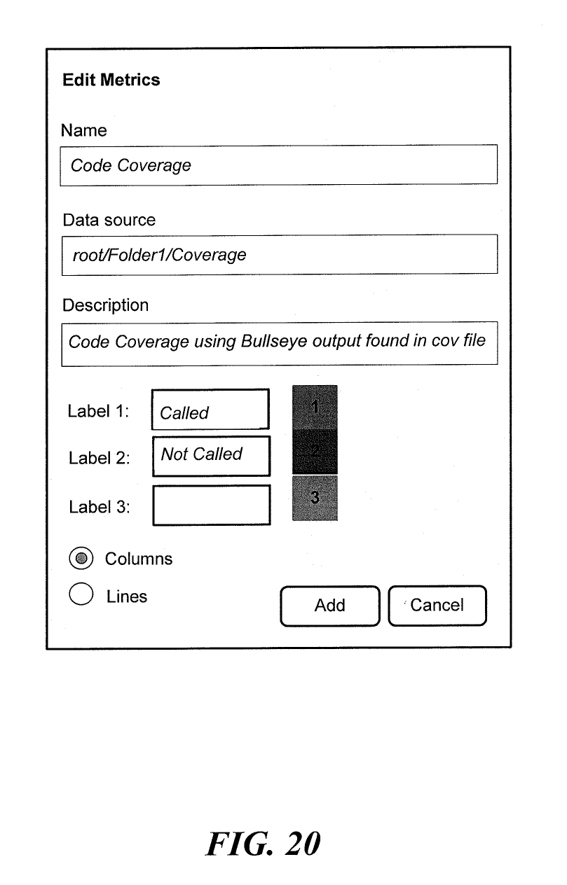

The test manager 210 may receive Test Commands requesting custom metric collection. FIG. 20 is an interface diagram showing an example of a custom metric interface. The test manager 210 may provide the interface shown in FIG. 20 to receive code coverage metric test design data. The code coverage data will be stored in the data source specified. The custom interface receives an indication as to whether the data is maintained in rows or columns. The customer interface also receives labels and color selections to use for representing the collected custom metrics. One non-limiting advantage of the custom metrics is facilitating other types of analysis, outside of traditional test pass or test fail results, to be collected and centralized with the design, automation, and status information. For example, a code coverage tool may provide a functional coverage report in XML format. This report may be converted to standardized format that can be included within the Schema. The standardized format may be name-value pairs where the name is the name of the metric and the value is information indicating the measured/observed metric. The conversion may be performed by the tool producing the report. In some implementations, the conversion may be performed by a separate module configured to apply a transformation (e.g., XSLT) to the output to generate an ingestible custom metric report.

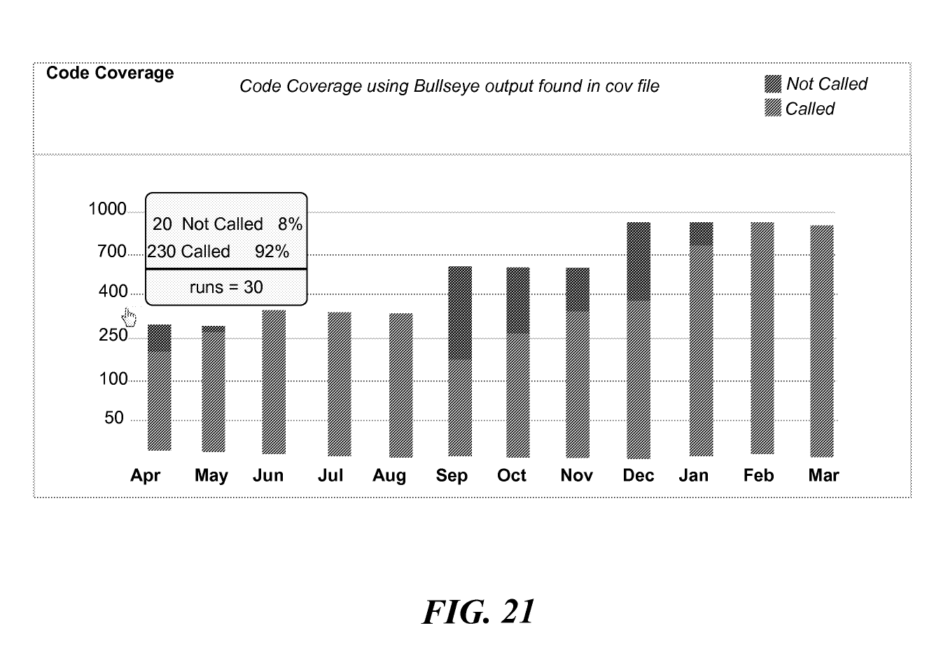

FIG. 21 is an interface diagram showing an example of a report including a captured custom metric over a period of time. The test manager 210 may provide an integrated view of the custom metrics, test reports, along with the Schema, current status, collaborative content and/or documentation, file attachments, messages, and actionable to-do items. The report may be interactive. As shown in FIG. 21, as a pointer is moved along the report, a summary of the test metrics from the time period shown nearest to the location of the pointer is shown. In FIG. 21, because the hand pointer is nearest to April, the summary of test results shown is for the April testing.

As a further example implementation including features described above, a Space Schema is used to create a test hierarchy representing the design, execution control, and the current status. By integrating these three activities the testing process is easier to maintain and communicate to others. A Schema may be defined as a root directory and a collection of Folders and Suites. The purpose of a Folder is to organize a group of closely related Suites and child Folders. The purpose of a Suite is to represent an executable unit containing one or more Test Cases. A Test Case may define a set of logic that determines correctness (pass or fail) and optionally a collection of test logs or annotations. A Suite can be implemented (represented by) a framework, scripts, applications, etc.

The Schema may include variables. Two types of Schema variables that may be supported are system and user-defined. System variables provide access to field names, path, etc., and fixture control for Folders within a Schema hierarchy. User-defined variables are associated with a Folder and can be referenced by any children items (such as Folders and Suites) included in the Folder.

Because the Schema may be accessed by the test runner to initiate and/or control execution, leveraging Schema variables within the design can be very useful. All variables are instantiated during the test runner's test execution and are fully accessible to corresponding applications, scripts, etc., using a standard syntax for operating system environment variables.

Table 1 provides a list of example system variables which can be implemented by the Schema and accessed by a test runner. The runner scope of access indicates what activities the runner may take with the variable. If the variable is read only, in this implementation, the runner may only read the information referenced by the variable. If the variable is write only, in this implementation, the runner may only write a value to the variable. The prefix self indicates the variable will resolve in the context of its referenced location. The prefix of suite is a lazy-load type variable that is resolved at the point of an executable command.

TABLE 1

| | Runner Scope | |
|---|---|---|
| Name | of Access | Comments |
| self.name | Read only | Returns name of a Folder or Suite |
| self.path | Read only | Returns the path of a Folder or Suite |
| self.input | Read only | Returns the path of a file containing |
| | | the Suite input |
| self.result | Read only | Returns the path of a file where Suite or |
| | | Folder xml output should be written to |
| self.init | Write only | Assign command to execute at beginning |
| | | of the Folder |
| self.deinit | Write only | Assign command to execute at the |
| | | end of the Folder |
| suite.name | Read only | Returns name of current Suite |
| suite.path | Read only | Returns the path of current Suite |
| suite.input | Read only | Returns the path of a file containing the |
| | | current Suite input |
| suite.result | Read only | Returns the path of a file where the current |
| | | Suite xml output should be written to |
| suite.id | Write only | Settable within a Folder; default identifier |
| | | for any children Suites within the Folder |

Within a Folder user-defined variables can be defined and/or referenced. Variables may be created as name-value pairs.

A Suite represents an executable unit, with optional settings, containing one or more Test Cases. A Suite can be individually invoked by a test runner using its identifier. The Suite includes the information to execute the corresponding test cases and provide test results. A Suite can be: a Script (perl, Python, batch, shell script, etc.), an application, a group of tests within a Test Framework such as Google Test, JUnit, etc., or the like. When a Suite is declared as a standalone runnable entity within a Schema, a Name and an execution identifier may be collected. The Name may be textual information describing the Suite. The execution identifier is the information needed to invoke the suite. For example the execution identifier may be a fully qualified path to an application along with command-line options for executing the application. When the Suite is obtained by a test runner, the test runner will attempt to run the execution identifier on the command line. Because the command line will be used to process the execution identifier, applications (e.g., executables), operating system commands, and host scripts can be used.

The results of the Suite may be copied to or referenced within a system variable such as suite.result system variable discussed above. This allows the result of a first command to be passed to a second command or results from a chain of commands to be compiled into a single result file. The results of the Suite may be automatically consumed and aggregated with previous results during the Schema run. If the Suite does not generate compliant results the test runner may be configured to create a one test case result, named “process”, with pass (e.g., 0)/fail (e.g., non-0) based on the process execution status.

Suites may include optional Input that can be defined within the Schema. The input is entered within the Suite editor box and persisted within the Schema. The test runner may obtain the input and create a temporary file containing the content. The path of the input file may be provided using a system variable such as suite.input.

Executable snippets of code in a scripting language may be supported within a Suite. The Suite's Input can be used to contain a collection of commands or instructions. The first line containing the commands may include an indicator which identifies the text that follows is a script executable by a predefined parser. For example, “#.bat” may be used to indicate the remaining input should be interpreted as a Windows batch file.

Folders may be provided to group in scope testing functionality with similar scope. Some of the non-limiting advantages of a Folder are: grouping similar in scope testing functionality; applying a description to the Folder to better document the purpose of its child Suites; summary rollups of pass/fail results at each Folder level; creation of user-defined variables inherited by any child Suites and Folders; environment variables values set only active in the context of the Folder execution. A Folder's settings can be used to define/reference Schema Variables, or contain a set of executable Commands (e.g., Script). As with Suites, Folders can include a name, an execution identifier, input which can be accessed by any Folders or Suites included in the Folder.

Because the Schema includes variables, the values represented by the variables may be resolved dynamically. The dynamic resolution allows variables to be updated at runtime (e.g., when accessed/executed by a test runner). This provides one non-limiting advantage of avoiding statically defining values used for testing which would likely require significant updating to the entire plan if changed. The variables also permit nesting such that a variable may include other variables. This can be useful in, for example, cross-platform testing where files or other resources may be stored in different locations. In such implementations, the base path for a resource may resolve at runtime for the test runner's operating system while the resource name may resolve to the same value for all instances of the test runner.

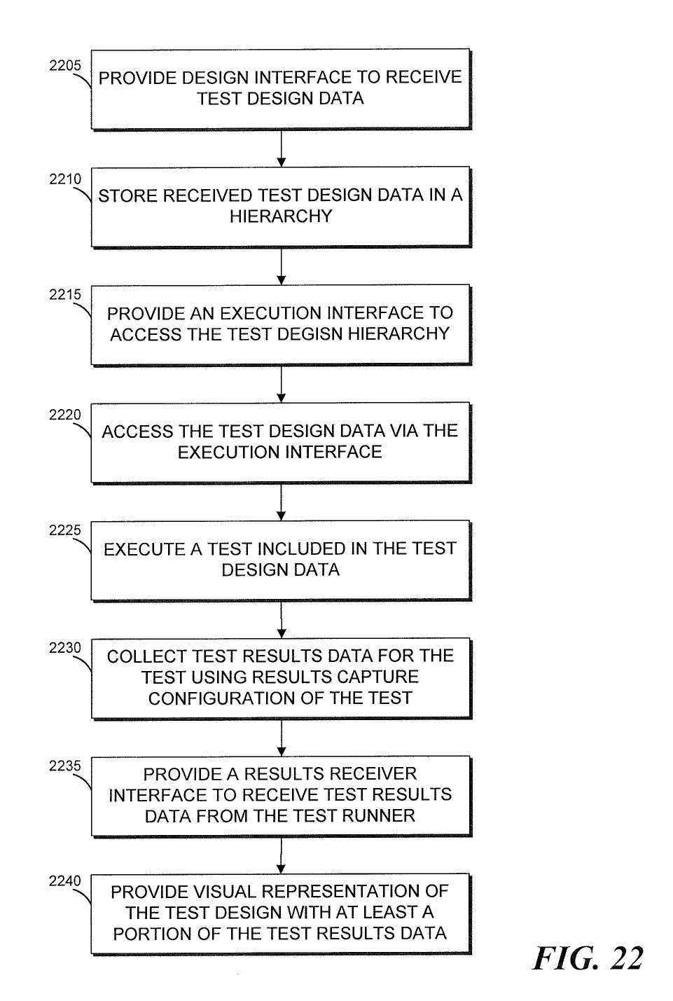

FIG. 22 is a process flow diagram illustrating a method of integrated test planning/design, automation, and analysis. The method shown in FIG. 22 may be implemented in whole or in part by one or more of the devices shown and described herein such as the integrated testing system 200 shown in FIGS. 2-5.

At block 2205, a design interface is provided to receive test design data. The design interface may be a graphical user interface such as those shown in the figures. The design interface may include a machine interface such as a web-services interface to allow devices to exchange test design data. If graphical, interface may include one or more control elements configured to receive test design data. The test design data may include one or more of a functional test group, an order of test execution, indicators of tests to run, a runtime configuration for a test to be run, procedural instructions for manual tests, variables for a test, parameters for a test, a results capture configuration for a test, and a description for a test. In some implementations, the design interface includes a file upload control configured to receive a file attachment.

At block 2210, received test design data is stored in a hierarchy. A Schema as described above may be used to organize and store the test design data. Storing data in the Schema may include receiving a node identifier indicating a location within the Schema for storing the test design data. In implementations where file attachments are received, receiving at block 2210 may include associating the file attachment with a portion of the hierarchy

At block 2215, an execution interface to access the test design hierarchy is provided. The execution interface may be accessible by a test runner. The execution interface may include a machine interface such as a web-service interface for discovering and/or executing tests. In some implementations, the execution interface may include a graphical user interface which includes a control element for receiving an execution command.

At block 2220, the test design data is access via the execution interface. The access may be via a client device or via a test runner. At block 2225, a test included in the test design data accessed is executed. The execution may include parsing the test design data to obtain the execution identifier for the test. The execution identifier may then be submitted to the test runner host system for execution. In some implementations, the execution may include resolving variables included in the test design data. The resolution may be included as part of the processing at block 2225. In some implementations, the resolution of variables may be performed at block 2220 such that a variable in the accessed test design data is resolved when received by the accessing party (e.g., test runner). The execution may use the test design data obtained via the execution interface. For example, the execution may use at least one of a runtime configuration associated with the test, variables for the test, or parameters for the test as identified in the obtained test design data.

At block 2230, test results data is collected for the test using a results capture configuration for the test. The results capture configuration may be a variable for the test. Collecting the data may include capturing output from the process executed at block 2225. Collecting the data may include accessing a result file generated by the process executed at block 2225. In some implementations, the data may be collected through a process. For example, an application may be executed to query a relational database for test data and report the results back to the test runner for collection. The test results data may include information indicating at least two of a test status of a plurality of test statuses, the plurality of test statuses including pass, fail, and not applicable; a test time duration; test log information; a console output from the test; or general annotations for the test, where a general annotation includes at least one of textual data, audio data, or video data for the test.

At block 2235, a results receiver interface is provided to receive the test results data collected at block 2230. The results receiver interface may be a graphical user interface such as those shown in the figures. The results receiver interface may include a machine interface such as a web-services interface to allow devices to submit test results. Submitted results may be accompanied by an identifier for the test, suite, or folder to which the results should be stored. If graphical, interface may include one or more control elements configured to receive test results data.

At block 2240, a visual representation of the test design overlaid with at least a portion of the test results data is provided. Examples of visual representations are shown in FIGS. 16-19, 21, and 22. In some implementation providing the visual representation may include transmitting one or more messages including the visual representation without necessarily displaying the visual representations such as on a monitor or smartphone.

In some implementations, the method may include additional or alternative features. For example, additional information may be received for the test design such as collaborative content system documents or actionable to-do items. For example, the method may include generating a visual test report based on historical test results data received and providing an interface to present the visual test report. A visual test report may identify test pass fail rates over a period of time, tests executed over time a period of time, status of a system under test based on results analysis, and/or quantity of the system under test subjected to testing during a test execution.

In the detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed there between. Also, when an element is referred to as being “connected to” another element, it can be directly connected to the another element or be indirectly connected to the another element with one or more intervening elements interposed there between. The present embodiments may have different forms and should not be construed as being limited to the descriptions set forth herein. Accordingly, the embodiments are merely described, such as by referring to the figures, to explain aspects of the present description.

The detailed description set forth in connection with the appended drawings is intended as a description of exemplary embodiments and is not intended to represent the only embodiments in which the invention may be practiced. The term “exemplary” and “example” used throughout this description means “serving as an example, instance, or illustration,” and should not necessarily be construed as preferred or advantageous over other exemplary embodiments. The detailed description includes specific details for the purpose of providing a thorough understanding of the exemplary embodiments. It will be apparent that the exemplary embodiments may be practiced without these specific details. In some instances, some devices are shown in block diagram form.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrequited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; and use of terms like ‘preferably,’ ‘preferred,’ ‘desired,’ or ‘desirable,’ and words of similar meaning should not be understood as implying that certain features are critical, essential, or even important to the structure or function, but instead as merely intended to highlight alternative or additional features that may or may not be utilized in a particular embodiment. In addition, the term “comprising” is to be interpreted synonymously with the phrases “having at least” or “including at least”. When used in the context of a process, the term “comprising” means that the process includes at least the recited steps, but may include additional steps. When used in the context of a compound, composition or device, the term “comprising” means that the compound, composition or device includes at least the recited features or components, but may also include additional features or components. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

As used herein, the term “determining” encompasses a wide variety of actions. For example, “determining” may include calculating, computing, processing, deriving, investigating, looking up (for example, looking up in a table, a database, or another data structure), ascertaining, generating, and the like. Also, “determining” may include receiving (for example, receiving information), accessing (for example, accessing data in a memory), and the like. Also, “determining” may include resolving, selecting, choosing, establishing, and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like, or a combination thereof “Providing” may also include encoding, decoding, encrypting, decrypting, validating, verifying, and the like.

As used herein, the terms “obtain” or “obtaining” encompass a wide variety of actions. For example, “obtaining” may include retrieving, calculating, receiving, requesting, and the like, or a combination thereof. Data obtained may be received automatically or based on manual entry of information. Obtaining may be through an interface such as a graphical user interface.

As used herein a graphical user interface may include a web-based interface including control elements (e.g., text input fields, check boxes, radio buttons, file upload controls, select lists, drop down menus, graphical buttons, gesture detection, and other tangible means for presenting and/or receiving data input values) for receiving input signals or providing electronic information. The graphical user interface may be implemented in whole or in part using technologies such as HTML, Flash, Java, .net, web services, and RSS. In some implementations, the graphical user interface may be included in a stand-alone client (for example, thick client, fat client) configured to communicate in accordance with one or more of the aspects described. In some implementations, the graphical user interface may be implemented using hardware elements such as buttons, LEDs, control gates, and other circuit elements arranged to provide one or more of the described features.

As used herein, the term “message” encompasses a wide variety of formats for representing information for transmission. A message may include a machine readable aggregation of information such as an XML document, fixed field message, comma separated message, or the like. While recited in the singular, it will be understood that a message may be composed/transmitted/stored/received/etc. in multiple parts.

While this invention has been described in connection with what is are presently considered to be practical embodiments, it will be appreciated by those skilled in the art that various modifications and changes may be made without departing from the scope of the present disclosure. It will also be appreciated by those of skill in the art that parts mixed with one embodiment are interchangeable with other embodiments; one or more parts from a depicted embodiment can be included with other depicted embodiments in any combination. For example, any of the various components described herein and/or depicted in the Figures may be combined, interchanged, or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the scope of the appended claims, and equivalents thereof.

What is claimed is:

1. An integrated test planning/design, automation, and analysis system comprising:
a test manager configured to:
provide a design interface to receive test design data;
store received test design data in a hierarchy; and
provide an execution interface access to the test design hierarchy; and
a test runner configured to:
access the test design data via the execution interface;
execute a test included in the test design data; and
collect test results data for the test using a results capture configuration for the test,
wherein the test manager is further configured to:
provide a results receiver interface configured to receive the test results data from the test runner; and
provide a visual representation of the test design overlaid with at least a portion of the test results.

2. The system of claim 1, wherein the test design data includes one or more of a functional test group, an order of test execution, indicators of tests to run, a runtime configuration for a test to be run, procedural instructions for manual tests, variables for a test, parameters for a test, a results capture configuration for a test, and a description for a test.

3. The system of claim 1, wherein the test runner is configured to execute the test using at least one of:
a runtime configuration associated with the test;
variables for the test; or
parameters for the test.

4. The system of claim 1, wherein the test manager is further configured to associate a document stored in a collaborative content system with a portion of the hierarchy.

5. The system of claim 1, wherein the design interface includes a file upload control configured to receive a file attachment, wherein the test manager is further configured to associate the file attachment with a portion of the hierarchy.

6. The system of claim 1, wherein the test manager is further configured to:
receive messages or to-do items for a portion of the hierarchy; and
associate the messages or the to-do items with the portion of the hierarchy.

7. The system of claim 1, wherein the test results data includes information indicating at least two of:
a test status of a plurality of test statuses, the plurality of test statuses including pass, fail, and not applicable;
a test time duration;
test log information;
a console output from the test; or
general annotations for the test, a general annotation comprising at least one of textual data, audio data, or video data for the test.

8. The system of claim 1, wherein the test manager is further configured to:
generate a visual test report based on historical test results data received; and
provide an interface to present the visual test report,
wherein the visual test report identifies:
test pass fail rates over a period of time;
tests executed over time a period of time;
status of a system under test based on results analysis; and
quantity of the system under test subjected to testing during a test execution.

9. The system of claim 1, wherein the test design is persisted.

10. The system of claim 1, wherein the test manager is configured to provide a summary interface including a visual representation of the test hierarchy with a most recent test result received from a test runner.

11. The system of claim 10, wherein the visual representation of the test design associated with the test results is based on the most recent test results.

12. The system of claim 10, wherein the summary interface includes an aggregation of the most recent test results over a period of time.

13. A method for integrated test planning/design, automation, and analysis system comprising:
providing a design interface to receive test design data;
storing received test design data in a hierarchy;
providing an execution interface to access the test design hierarchy;
accessing the test design data via the execution interface;
executing a test included in the test design data;
collecting test results data for the test using a results capture configuration for the test;
providing a results receiver interface configured to receive the test results data from the test runner; and
providing a visual representation of the test design overlaid with at least a portion of the test results data.

14. The method of claim 13, wherein the test design data includes one or more of a functional test group, an order of test execution, indicators of tests to run, a runtime configuration for a test to be run, procedural instructions for manual tests, variables for a test, parameters for a test, a results capture configuration for a test, and a description for a test.

15. The method of claim 13, wherein executing the test comprises executing the test using at least one of:
a runtime configuration associated with the test;
variables for the test; or
parameters for the test.

16. The method of claim 13, further comprising associating a collaborative content system document with a portion of the hierarchy.

17. The method of claim 13, wherein the design interface includes a file upload control configured to receive a file attachment, wherein the method further comprises associating the file attachment with a portion of the hierarchy.

18. The method of claim 13, further comprising:
receiving messages or to-do items for a portion of the hierarchy; and
associating the messages or the to-do items with the portion of the hierarchy.

19. The method of claim 13, wherein the test results data includes information indicating at least two of:
a test status of a plurality of test statuses, the plurality of test statuses including pass, fail, and not applicable;
a test time duration;
test log information;
a console output from the test; or
general annotations for the test, a general annotation comprising at least one of textual data, audio data, or video data for the test.

20. The method of claim 13, further comprising:
generating a visual test report based on historical test results data received; and
providing an interface to present the visual test report,
wherein the visual test report identifies:
test pass fail rates over a period of time;
tests executed over time a period of time;
status of a system under test based on results analysis; and
quantity of the system under test subjected to testing during a test execution.
